(19) United States
(12) Patent Application Publication
(10) Pub. No.: US 2002/0127306 A1
(43) Pub. Date: Sep. 12, 2002

(54) SWEET AND SALTY MICROWAVE POPCORN COMPOSITIONS; ARRANGEMENTS AND METHOD

(75) Inventors: Ms. Lisa Marie Schmidt, Waconia, MN (US); Mr. Michael Laurence Jensen, Minnetonka, MN (US)

Correspondence Address: Merchant & Gould, Mara Liepa, 80 S. 8th Street, Suite 3200, Minneapolis, MN, 55402, US, 612-332-5300, 612-332-9081

(73) Assignee: ConAgra, Inc., Omaha, 68102 (US)

(21) Appl. No.: 09/795,571

(22) Filed: Feb. 28, 2001

(51) Int. Cl. A23B 4/00

(52) U.S. Cl. 426/107

(57) ABSTRACT

### Abstract of Disclosure

A sweet and salty microwave popcorn composition is provided. The sweet taste is provided by using a sweetening effective amount of sucralose in the composition. The salt taste is provided by using an effective amount of sodium chloride or common salt. Various sugar components (monosaccharides and non-sucralose disaccharides) are preferably avoided, to accomplish a desirable taste without burn. Microwave popcorn products using compositions as characterized, and preferred methods, are also provided.

### Background of Invention

The present invention relates to microwave popcorn. The invention particularly concerns methods and compositions for flavoring microwave popcorn to achieve a sweet and salty flavor.

Microwavable popcorn (sometimes referred to as microwave popcorn) is a popular consumer item. In general, the form of product obtained by the consumer includes an unpopped popcorn composition enclosed within a disposable container, such as a paper container or fiber board (or paper board) container. In many instances, microwave susceptors (microwave interactive constructions) are provided on or within the container to facilitate collection of microwave energy and heat transfer to the popcorn composition during popping. The product is typically used by placing the disposable container, with the unpopped popcorn therein, inside a microwave oven. After exposure to microwave energy in a conventional microwave oven for about 1-5 minutes, typically about 95% of the popcorn converts to its popped form. Microwave popcorn arrangements for use in this manner are described, for example, in U.S. patents 5,044,777; 4,548,826; 4,691,374; 4,450,180; 5,650,084; 5,008,024; 5,834,046 and 5,097,107; the disclosures of these patents being incorporated herein by reference.

Many consumers prefer their microwave popcorn to be flavored. A desirable manner to provide a flavor is to include appropriate flavoring materials within the popcorn composition before popping, so that, as popped, the microwave popcorn is provided with the desired taste, without necessity of an added post-pop flavoring step. For example, a salty taste can be provided by including appropriate levels of a salt, typically sodium chloride (NaCl), in the microwave popcorn composition. The following commercial microwave products, available from Golden Valley Microwave Foods of Eden Prairie, Minnesota, are examples of products that currently provide significant salt taste when popped: "Act II Natural Microwave" and "Act II Butter Microwave Popcorn:. This salted taste is a result of including sodium chloride in the microwave composition contained within the product enclosure prior to popping. Microwave popcorn formulations that use sodium chloride to provide a salty taste are described in the following U.S. patents, incorporated herein by reference: U.S. Patent Nos. 5,585,127; 5,750,166; 5,993,869; and 6,083,552.

Some consumers enjoy a sweet flavor to their microwave popcorn. One method of providing a sweet flavor in the microwave popcorn is to include a sweetener within the microwave popcorn composition prior to popping. A problem with this approach is that sweeteners are often susceptible to undesirable levels of burning during the microwave popping operation, thus providing an undesirable taste. This problem is discussed, for example, in U.S. patent 5,443,858, the complete disclosure of which is incorporated herein by reference.

There are also consumers that enjoy the combination of the two flavors: a sweet and salty, or salty and sweet, taste. Examples of common sweet and salty foods include chocolate covered peanuts, sugar frosted or chocolate covered pretzels, and honey roasted peanuts. It would be desirable to develop an acceptable sweet and salty microwave popcorn product.

### Summary of Invention

A microwavable popcorn composition is provided. The popcorn composition is such that upon popping it provides a popcorn product having an acceptable sweet and salty taste. By the term "acceptable" in this context, it is meant that a sweet and salty taste is developed, without an unacceptable level of burned or bitter taste.

The composition, in general, comprises unpopped popcorn, an oil/fat component, at least an amount of salt effective to provide a desirable salty flavor, and at least a sweetening effective amount of sucralose. The term "sweetening effective amount" in this context, is meant to refer to an amount of sucralose adequate so that a detectable sweet component is provided to the overall flavor of the product. Thus, in combination with the salt, a sweet and salty taste is provided by the sucralose.

A typical preferred composition includes 64-70% unpopped popcorn, 29-33% oil, 0.9-1.8% salt (typically sodium chloride) and 0.02-0.2% sucralose, all by weight percent of the total unpopped popcorn composition.

Preferably, the composition includes less than 2% monosaccharides (more preferably less than 1% monosaccarides), less than 2% disaccharides not including sucralose (more preferably less than 1% of such sugars), and less than 2% corn syrup solids (more preferably less than 1% corn syrup solids). Preferably, the total amount of added monosaccharides, disaccharides other than sucralose, and corn syrup solids in the composition is minimal (e.g., less than 1%), and, if the components are present at all, they are in a minimum effective amount to provide any desirable flavor modifications.

According to the present invention, a preferred microwave popcorn product is provided which comprises a container suitable for use in a microwave popping process, with a microwave popcorn composition as characterized above provided inside the container, in thermoconductive relation to a microwave interactive construction. The term "microwave interactive construction" in this context is meant to refer to a material which, (upon exposure of microwave energy) becomes heated and thus can transfer heat to the microwave popcorn composition. Typical microwave interactive compositions comprise metallized substrates, for example an aluminized or metalicized polymer sheet. The term "thermoconductive relation" is meant to refer to a proximity close enough so that when exposed to microwave energy, heat generated by the microwave interactive construction is detected in the region where the popcorn composition resides.

The container may be, for example, a flexible paper bag, such as a two-ply bag, having a microwave interactive construction mounted on or in the bag. Alternatively, the package may be a fiberboard tub, having a microwave susceptor positioned on or inside the tub.

According to the present invention, a method for preparing a sweet and salty popcorn food is provided. The method, in general, comprises a step of popping a preferred popcorn composition, as characterized herein, by microwave treatment or microwave heating. The terms "microwave treatment" and "microwave heating" in this context are meant to refer to a popping operation which concerns exposure of the microwave popcorn composition to microwave energy in a microwave oven and is meant to include within its scope such an exposure while the microwave popcorn composition is in thermoconductive contact with a microwave susceptor.

### Brief Description of Drawings

Fig. 1 is a front perspective view of an arrangement incorporating a microwave popcorn composition according to the present invention; the arrangement of Figure 1 being depicted closed in a storage overwrap and oriented standing on an edge.

Fig. 2 is the schematic top plan view of an arrangement according to Fig. 1, depicted unwrapped and unfolded, as it would be when positioned in a microwave oven for cooking.

Fig. 3 is a front perspective view generally analogous to Fig. 1, with portions broken away to show internal detail and without the overwrap.

Fig. 4 is a cross-sectional view taken generally along line 4-4, Fig. 2.Fig. 5 is a schematic, plan view of a package blank showing an adhesive pattern useable to generate a bag useable in the arrangement of Figs. 1-4.

Fig. 6 is a schematic cross-sectional view of a fiberboard tub including a microwave popcorn composition according to the present invention.

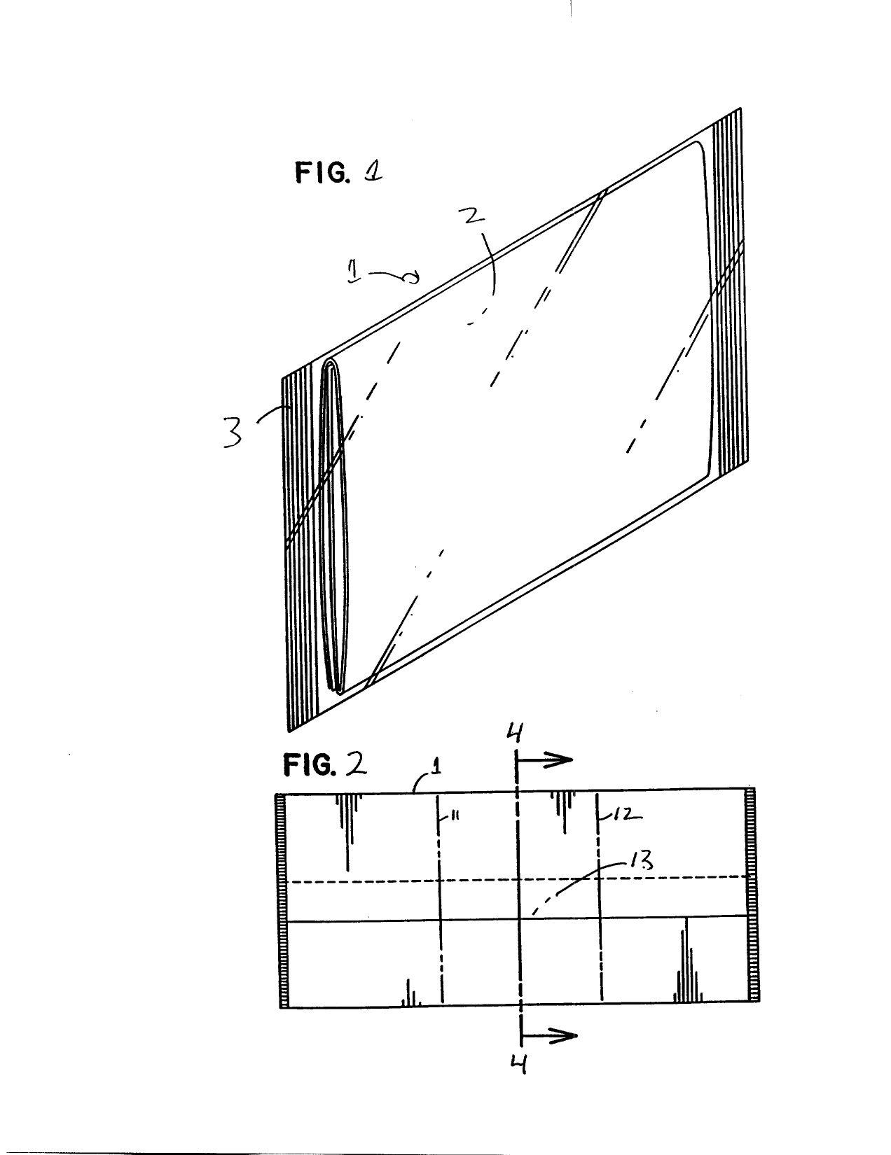

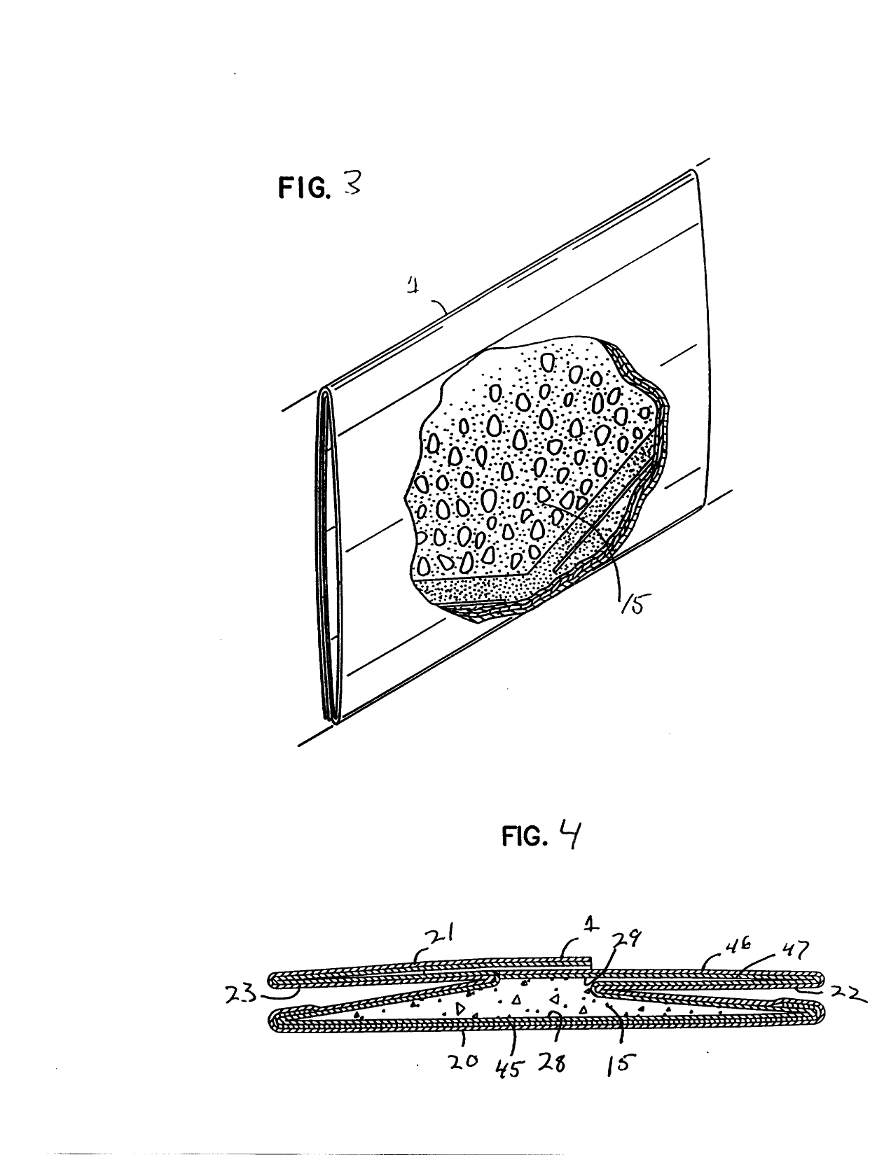

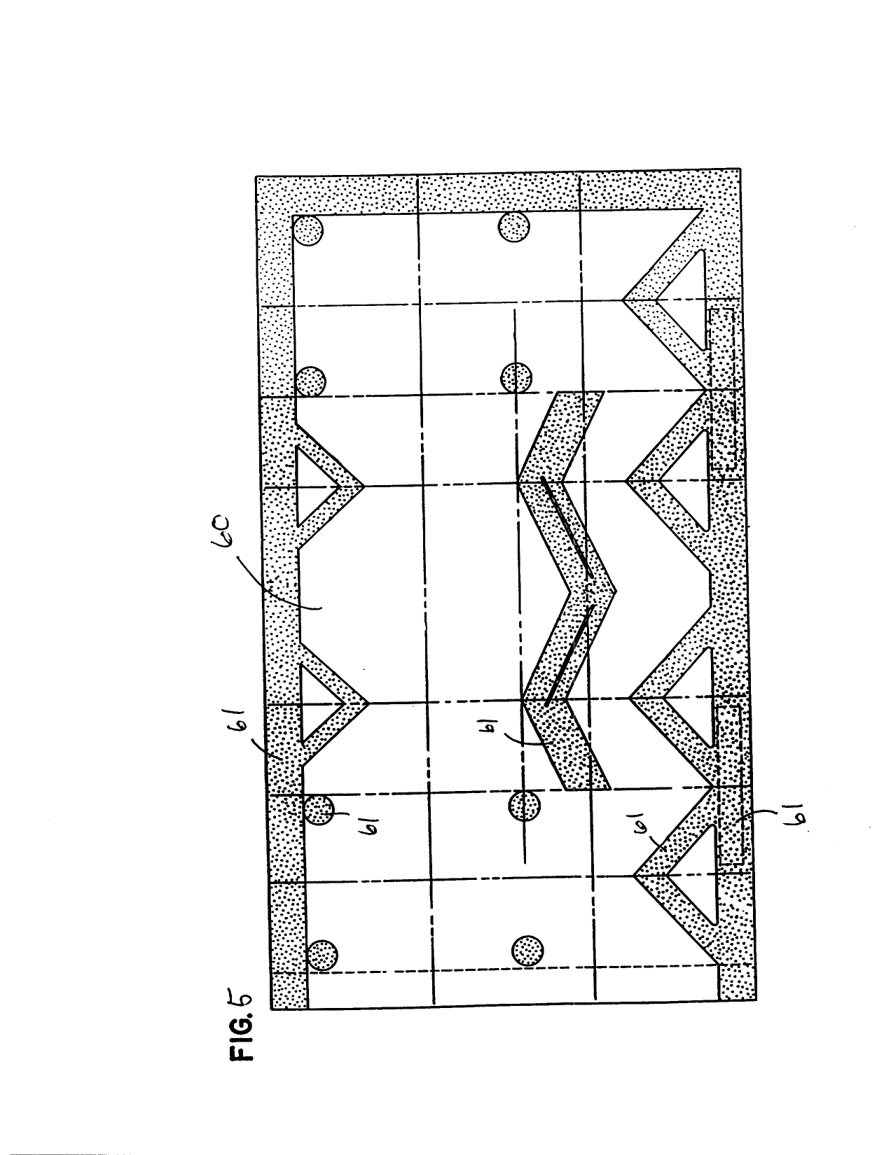

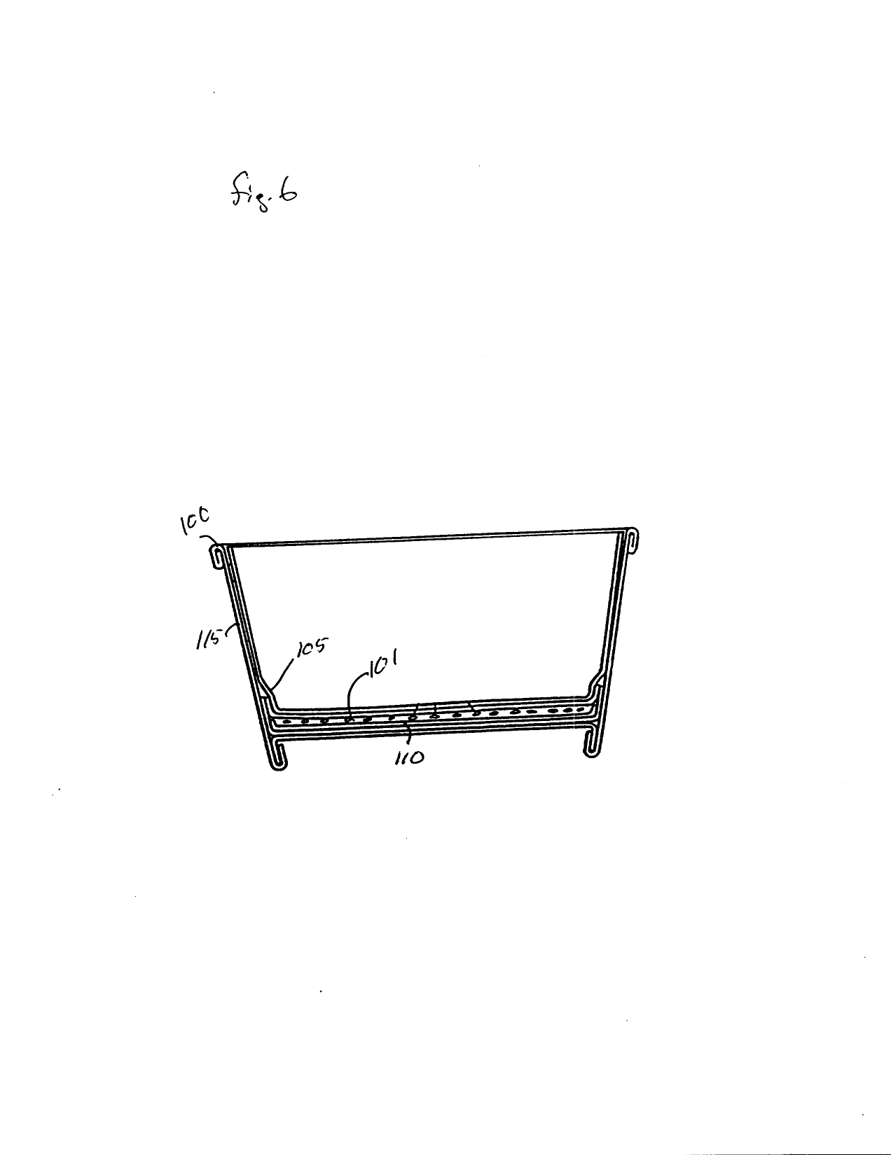

### Detailed Description

As indicated above, the present invention relates to microwave popcorn. The invention concerns a popcorn composition suitable for microwave popping, which includes, in addition to the popcorn, appropriate agents to provide the eventual product with a desirable sweet and salty taste, even in the absence of additional "post-pop additive(s)". Herein the term "post-pop additive(s)" and variants thereof, is meant to refer to flavorants or other adjuvants added after the popping process is completed. The invention, then, concerns providing a preflavored microwavable popcorn composition, which can then be popped to provide a desirable sweet and salty flavor in the final product.

By the phrase "even in the absence of additional "post-pop additive(s)""it is not meant that the compositions according to the present invention cannot be used in association with post-pop additives. Rather, it is meant that, at least with respect to the tastes of the general population, a sweet and salty taste will be provided by the composition without the requirement of additional post-pop additives.

In the past, provision of a sweet flavor in microwave popcorn (prior to popping) has raised significant difficulties. The difficulties generally concern undesirable burn or burned taste resulting from burning of the sugars present in sweetened flavorings as the popcorn is popped in the microwave system. This problem is described in U.S. patent 5,443,858, incorporated herein by reference. In the '858 patent, the problem was addressed by providing a unique flavor composition which, among other things, preferably contained no more than 200 mg of sodium chloride per 100 grams of glazing blend, most preferably no more than 140 mg per 100 grams of glazing blend. The term "glazing blend" as used in the '858 patent, referred to all components in the popcorn composition other than the popcorn itself. Thus, the amount of salt acceptable in the popcorn compositions of that reference was very low.

In order to obtain an acceptable salty taste, it is generally necessary to provide a level of at least 0.5 gram salt per 66 grams popcorn (unpopped), typically at least 0.8 gram salt per 66 grams popcorn (unpopped); and preferably about 0.9-1.8 grams salt per 66 grams popcorn (unpopped). This amount of salt in the composition is too high to use the techniques of the '858 patent to obtain a sweet flavoring, without unacceptable levels of burn. According to the '858 patent, column 4, lines 51-62, to avoid undesirable burn, it is necessary to minimize the amount of salt (sodium chloride) when the flavoring composition includes sweeteners. It has been theorized that the burn generally results from dissociation of the sodium chloride in the presence of moisture in the system, with resulting hot spots generated in the microwave field. See Microwave Foods: New Product Development, by R.V. Decareau, 1992, pp. 48-50, incorporated herein by reference.

It has been found that a desirable sweet and salty taste composition, which does not lead to undesirable levels of burn in a typical microwave popping operation, can be obtained by using of particular sweetening agents in defined levels, and preferably in a composition that minimizes, and most preferably excludes, the presence of other types of sweeteners. A particular sweetening agent useable to provide the sweet flavor in sweet and salty compositions according to the present invention is 1,6-dichloro-1,6-dideoxy-β-D-fructofuranosyl-4-chloro-4-deoxy-α-D-galactopyranoside, generally known as sucralose. Kirk-Othmer's Encyclopedia of Chemical Technology, fourth edition, alternately defines sucralose as 4,1',6'-trichloro-4,1',6'-trideoxygalactosucrose. A still further name is 1',4,6'-trichloro-rogalatosucrose. The sweetener is also described in European patent application 87308260.6 (publication No. 0 260 979) filed September 17, 1987 and published March 23, 1988. One commercially available sucralose is SPLENDA^{®} brand sweetener powder from McNeil Specialty Products Company.

Sucralose is similar to common sugar, in that it is a generally white, crystalline powder and practically odor free. However, sucralose has about 450 to 650 times the sweetness of sugar (i.e., sucrose), yet is said to add no calories to the food product. The molecular formula is C₁₂H₁₉Cl₃O₈ and it has a molecular weight of about 398. The commercial product available as usable sucralose will typically be at least 98% sucralose, more typically at least 99% sucralose, the remainder being residuals left from the manufacturing process or other trace impurities.

Sucralose is preferred for the present invention because it has been found that various monosaccharides (galactose, fructose (levulose), glucose (dextrose), and dextrose derivatives, for example) and disaccharides (such as sucrose, maltose, lactose and cellobiose) have a significant tendency to burn in microwave popcorn systems, especially in the presence of significant amounts of salt.

It is understood that sucralose may be classified as a disaccharide because of its molecular structure. For this application, it is intended that sucralose is not included in the disaccharide family of sugars. Thus, where the term "disaccharide" or "disaccharides" is used, this is intended to not include sucralose. In some instances in this application, the terms "non-sucralose disaccharide", "disaccharides not including sucralose", or variations thereof may be used to emphasize that sucralose is not considered a disaccharide for this application.In general, for compositions according to the present techniques, the disaccharide levels (not including sucralose) should be limited to no more than about 2 weight-% of the total popcorn composition (popcorn plus flavor ingredients and oil/fat), typically no more than about 1 wt-%. The presence of monosaccharides (for example, the various dextrins such as maltodextrin) should also be limited to no more than about 2 weight-%, typically no more than about 1 weight-%, of the total microwave popcorn composition.

In general, for preferred compositions according to the present techniques, it is preferred that non-sucralose disaccharide levels are no more than about 0.6 weight-% of the total popcorn composition, and that the monosaccharide levels are no more than about 0.6 wt-%, of the total microwave popcorn composition. Preferably, the total of non-sucralose disaccharides and monosaccharides is less than about 1 wt-% of the total popcorn composition, even more preferably less than about 0.5%, and most preferably, there are no added disaccharides (not including sucralose) and/or monosaccharides.

Corn syrup solids are another sweetener that has a tendency to burn in the presence of salt. Corn syrup solids are produced from a process in which corn starch, or another starch, is hydrolyzed. "Dextrose equivalent" or DE values are a measure of the product's reducing power as a percentage of the reducing power of pure dextrose (D-glucose). Acid hydrolysis of corn starch takes place to a DE level of about 42 and, if a higher DE value is required, the hydrolysis is continued with enzymes. Corn syrup solids have a DE starting at about 20 DE; as the DE increases, the molecular weight decreases until the starch is broken down to pure glucose or dextrose, which has a dextrose equivalent of 100 DE. Preferably, the total corn syrup solid content in the popcorn composition is no greater than about 2 weight-% of the total composition, typically less than 1 weight-%, more preferably less than 0.6 wt-%, even more preferably less than 0.5 wt-%, and most preferably, is zero.

In general, the negative effects of burn are additive; that is, if enough components are present, each component which alone is not enough to provide an undesirable level of burn taste, the user may nevertheless taste undesirable burn in the product as a result of the sum of the various components. As a result, it is preferred that the total amount of natural sweeteners, which includes monosaccharides, non-sucralose disaccharides, corn syrup solids, and maltodextrin, present in the popcorn composition is less than 1 weight-%, more preferably less than about 0.5 wt-%, and preferably zero.

The following table provides a definition of preferred compositions according to the present invention.

Formulation 1A

| Ingredient | g/bag |
|---|---|
| Popcorn | 66.00 |
| Hydrogenated Soybean Oil | 32.00 |
| Corn Syrup Solids (Maltrin QD-M600) | 1.00 |

Comments: Popped popcorn had slight sweet taste. Popped popcorn had no burnt taste. No burning on inner package wall occurred during cooking.

Formulation 1B

| | |
|---|---|
| Ingredient | g/bag |
| Popcorn | 66.00 |
| Hydrogenated Soybean Oil | 32.00 |
| Maltodextrin (M050) | 1.00 |

Comments: Popped popcorn had very slight sweet taste. Popped popcorn had no burnt taste. No burning on inner package wall occurred during cooking.

Formulation 1C

| | |
|---|---|
| Ingredient | g/bag |
| Popcorn | 66.00 |
| Hydrogenated Soybean Oil | 32.00 |
| Maltodextrin (M180) | 1.00 |

Comments: Popped popcorn had very slight to slight sweet taste. Popped popcorn had no burnt taste. No burning on inner package wall occurred during cooking.

Formulation 1D

| | |
|---|---|
| Ingredient | g/bag |
| Popcorn | 66.00 |
| Hydrogenated Soybean Oil | 32.00 |
| Modified Food Starch (Pure Cote-B790) | 1.00 |

Comments: Popped popcorn had no detectable sweet taste. Popped popcorn had no burnt taste. No burning on inner package wall occurred during cooking.

Formulation 1E

| | |
|---|---|
| Ingredient | g/bag |
| Popcorn | 66.00 |
| Hydrogenated Soybean Oil | 32.00 |
| Sugar (granulated; from C&H) | 1.00 |

Comments: Popped popcorn had very slight sweet taste. Popped popcorn had no burnt taste. No burning on inner package wall occurred during cooking.

Formulation 1F

| | |
|---|---|
| Ingredient | g/bag |
| Popcorn | 66.00 |
| Hydrogenated Soybean Oil | 32.00 |
| Sugar (powdered; C&H) | 1.00 |

Comments: Popped popcorn had very slight sweet taste. Popped popcorn had no burnt taste. No burning on inner package wall occurred during cooking.

Conclusions from formulations 1A through 1F:The sweetening agents used in formulations 1A through 1F at 1gram/bag showed no signs of burning on the popcorn or interior surface of the microwave popcorn bag. Overall, these sweetening agents delivered a low sweetness intensity. The granular and powdered sugar had the highest sweetness intensity, followed by corn syrup solids. Maltodextrin and modified food starch contributed little to sweetness.

Experiment 2For Experiment 2, the popcorn compositions were similar to Experiment 1, except that Experiment 2 included common sweetening additives with some added salt.

Formulation 2A

| Ingredient | g/bag |
|---|---|
| Popcorn | 66.00 |
| Hydrogenated Soybean Oil | 31.50 |
| Corn Syrup Solids (Maltrin QD-M600) | 1.00 |
| Salt (Morton-200 Fine) | 0.5 |

Comments: After cooking the popped popcorn had a slight bitter/burnt taste. A large number of burnt particles on the inner package. Large burn score on the inner package wall, approximately 1.5″ × 1.5″ in size.

Formulation 2B

| | |
|---|---|
| Ingredient | g/bag |
| Popcorn | 66.00 |
| Hydrogenated Soybean Oil | 31.50 |
| Maltodextrin (M050) | 1.00 |
| Salt (Morton-200 Fine) | 0.5 |

Comments: After cooking the popped popcorn had a slight bitter/burnt taste. A small number of burnt particles on popped popcorn product and on the inner wall.

Formulation 2C

| | |
|---|---|
| Ingredient | g/bag |
| Popcorn | 66.00 |
| Hydrogenated Soybean Oil | 31.50 |
| Maltodextrin (M180) | 1.00 |
| Salt (Morton-200 Fine) | 0.5 |

Comments: After cooking the popped popcorn had a slight bitter/burnt taste. A large number of burnt particles on popped popcorn product and on the inner package wall.

Formulation 2D

| | |
|---|---|
| Ingredient | g/bag |
| Popcorn | 66.00 |
| Hydrogenated Soybean Oil | 31.50 |
| Modified Food Starch (Pure Cote-B790) | 1.00 |
| Salt (Morton-200 Fine) | 0.5 |

Comments: Popped popcorn had a slight bitter/burnt taste. A small number of burnt particles on cooked product and on the inner package wall.

Formulation 2E

| | |
|---|---|
| Ingredient | g/bag |
| Popcorn | 66.00 |
| Hydrogenated Soybean Oil | 31.50 |
| Sugar (granulated; from C&H) | 1.00 |
| Salt (Morton-200 Fine) | 0.5 |

Comments: Popped popcorn had a slight bitter or burnt taste. Dark browning over ausceptor area on inner package wall.

Formulation 2F

| | |
|---|---|
| Ingredient | g/bag |
| Popcorn | 66.00 |
| Hydrogenated Soybean Oil | 31.50 |
| Sugar (powdered; from C&H) | 1.00 |
| Salt (Morton-200 Fine) | 0.5 |

Comments: Popped popcorn had a slight bitter or burnt taste. Dark browning over susaceptor area on inner package wall.

Conclusions from formulations 2A through 2F:Compared to formulations 1A through 1F, the popped popcorn of formulations 2A through 2F developed a slight bitter flavor when enough salt was added to cause a significant salt taste. Burning occurred on the inner package wall during cooking. The burning decreased sweetness intensity of the sweetening agents.

Experiment 3For Experiment 3, the popcorn compositions were similar to Experiment 1, except that Experiment 3 included sucralose in combination with the common sweetening additives, and with no added salt.

Formulation 3A

| Ingredient | g/bag |
|---|---|
| Popcorn | 66.00 |
| Hydrogenated Soybean Oil | 31.90 |
| Corn Syrup Solids (Maltrin QD-M600) | 1.00 |
| Sucralose | 0.1 |

Comments: The popped popcorn had a slight bitter/burnt taste and slight to medium sweet taste. A large number of burnt particles were on the inner package wall. Large burn score on the inner package wall, approximate 3.5″ × 2.5″

Formulation 3B

| | |
|---|---|
| Ingredient | g/bag |
| Popcorn | 66.00 |
| Hydrogenated Soybean Oil | 31.90 |
| Maltodextrin (M050) | 1.00 |
| Sucralose | 0.1 |

Comments: The popped popcorn had a slight bitter/burnt taste and a slight to medium sweet taste. A small number of burnt particles were on the cooked product and on the inner package wall.

Formulation 3C

| | |
|---|---|
| Ingredient | g/bag |
| Popcorn | 66.00 |
| Hydrogenated Soybean Oil | 31.90 |
| Maltodextrin (M180) | 1.00 |
| Sucralose | 0.1 |

Comments: The popped popcorn had a slight bitter/burnt taste and a slight to medium sweet taste. A large number of burnt particles were on the cooked product and on the inner package wall.

Formulation 3D

| | |
|---|---|
| Ingredient | g/bag |
| Popcorn | 66.00 |
| Hydrogenated Soybean Oil | 31.90 |
| Modified Food Starch (Pure Cote-B790) | 1.00 |
| Sucralose | 0.1 |

Comments: The popped popcorn had a slight bitter/burnt taste and a slight to medium sweet taste. A small number of burnt particles were on the cooked product and on the inner package wall.

Formulation 3E

| | |
|---|---|
| Ingredient | g/bag |
| Popcorn | 66.00 |
| Hydrogenated Soybean Oil | 31.90 |
| Sugar (granulated; from C&H) | 1.00 |
| Sucralose | 0.1 |

Comments: The popped popcorn had a slight bitter/burnt taste and a slight to medium sweet taste. A small number of burnt particles were on the cooked product and on the inner package wall. Blackened spots were on the inner package wall over the susceptor area.

Formulation 3F

| | |
|---|---|
| Ingredient | g/bag |
| Popcorn | 66.00 |
| Hydrogenated Soybean Oil | 31.90 |
| Sugar (powdered; from C&H) | 1.00 |
| Sucralose | 0.1 |

Comments: The popped popcorn had a slight bitter/burnt taste and a slight to medium sweet taste. A small number of burnt particles were on the cooked product and on the inner package wall. Blackened spots were on the inner package wall and over the susceptor area.

Conclusions from formulations 3A through 3F:Compared to formulations 1A through 1F, a slight bitter/burnt flavor developed and burning occurred on the inner package wall during cooking of the popcorn for formulations 3A through 3F that had sucralose. The addition of sucralose to formulations 1A and 1F contributed a slight to medium sweet flavor that was even detectable over the bitter/burnt flavor.

Experiment 4For Experiment 4, sucralose was the only sweetener added, and there was no added salt.

Formulation 4A

| Ingredient | g/bag |
|---|---|
| Popcorn | 66.00 |
| Hydrogenated Soybean Oil | 33.00 |
| Sucralose | 0.001 |

Comments: Popped popcorn had no perceptible sweet taste. No burnt taste. No burning on inner package wall occurred during cooking.

Formulation 4B

| | |
|---|---|
| Ingredient | g/bag |
| Popcorn | 66.00 |
| Hydrogenated Soybean Oil | 32.99 |
| Sucralose | 0.01 |

Comments: Popped popcorn had a slight sweet taste. No burnt taste. No burning on inner package wall occurred during cooking.

Formulation 4C

| | |
|---|---|
| Ingredient | g/bag |
| Popcorn | 66.00 |
| Hydrogenated Soybean Oil | 32.94 |
| Sucralose | 0.06 |

Comments: Popped popcorn had an acceptable sweet taste. No burnt taste. No burning on inner package wall occurred during cooking.

Formulation 4D

| | |
|---|---|
| Ingredient | g/bag |
| Popcorn | 66.00 |
| Hydrogenated Soybean Oil | 32.91 |
| Sucralose | 0.09 |

Comments: Popped popcorn had an acceptable sweet taste. No burnt taste. No burning on inner package wall occurred during cooking.

Formulation 4E

| | |
|---|---|
| Ingredient | g/bag |
| Popcorn | 66.00 |
| Hydrogenated Soybean Oil | 32.90 |
| Sucralose | 0.10 |

Comments: Popped popcorn had an acceptable sweet taste. A large number of burnt particles were on the cooked product and the inner package susceptor area.

Formulation 4F

| | |
|---|---|
| Ingredient | g/bag |
| Popcorn | 66.00 |
| Hydrogenated Soybean Oil | 32.82 |
| Sucralose | 0.18 |

Comments: Popped popcorn had a strong sweet taste. A very large number of burns particles on cooked popcorn and on the inner package wall, concentrated on the ausceptor area.

Formulation 4G

| | |
|---|---|
| Ingredient | g/bag |
| Popcorn | 66.00 |
| Hydrogenated Soybean Oil | 32.50 |
| Sucralose | 0.50 |

Comments: Popped popcorn bad a strong/intense sweet taste, too intense. An extreme number of burnt particles on cooked popcorn and on the inner package wall, concentrated on the susceptor.

Conclusions from formulations 4A through 4G:Formulations 4A through 4G were formulated with different levels of sucralose and without additional sweetening agents. Sucralose has a minimum and maximum level at which it can be used without having a negative impact on the popped popcorn. At levels of 0.01 to 0.10 gram per bag (based on popcorn composition content of 99 grams) the product has an acceptable sweetness and acceptable amount of burnt particles on the inner package wall and product. Above 0.10 gram sucralose per bag (based on popcorn composition content of 99 grams) the popped product has an unacceptable level of burnt particles on the inner package wall, as well as an unacceptable level of burnt particles on the popped popcorn.

Experiment 5For Experiment 5, the popcorn compositions were similar to Experiment 4, except that Experiment 5 used sucralose with some added salt.

Formulation 5A

| Ingredient | g/bag |
|---|---|
| Popcorn | 66.00 |
| Hydrogenated Soybean Oil | 32.46 |
| Sucralose | 0.040 |
| Salt (Morton-200 fine) | 0.500 |

Comments: No burning of popcorn or packaging. No burnt taste. Mild sweet impact throughout, no salt taste detected.

Formulation 5B

| | |
|---|---|
| Ingredient | g/bag |
| Popcorn | 66.00 |
| Hydrogenated Soybean Oil | 31.96 |
| Sucralose | 0.04 |
| Salt (Morton-200 fine) | 1.00 |

Comments: No burning of popcorn or packaging. No burnt taste. Mild sweet flavor and mild salty flavor, both balanced. Acceptable for commercial product.

Formulation 5C

| | |
|---|---|
| Ingredient | g/bag |
| Popcorn | 66.00 |
| Hydrogenated Soybean Oil | 31.46 |
| Sucralose | 0.04 |
| Salt (Morton-200 fine) | 1.50 |

Comments: No burning of popcorn or packaging. No burnt taste. Sweet flavor upfront, mild to acceptable impact. Stronger salty flavor at end.

Formulation 5D

| | |
|---|---|
| Ingredient | g/bag |
| Popcorn | 66.00 |
| Hydrogenated Soybean Oil | 30.96 |
| Suralose | 0.04 |
| Salt (morton-200 fine) | 2.0 |

Comments: No burning of popcorn or packaging. No burnt taste. Strong salty flavor, starting to overpower sweet flavor impact.

Formulation 5E

| | |
|---|---|
| Ingredient | g/bag |
| Popcorn | 66.00 |
| Hydrogenated Soybean Oil | 30.46 |
| Sucralose | 0.04 |
| Salt (Morton-200 fine) | 2.50 |

Comments: No burning of popcorn or packaging. No burnt taste. Unacceptable salty flavor, no sweet flavor.

Formulation SF

| | |
|---|---|
| Ingredient | g/bag |
| Popcorn | 66.00 |
| Hydrogenated Soybean Oil | 29.96 |
| Sucralose | 0.04 |
| Salt (Morton-200 fine) | 3.00 |

Comments: No burning of popcorn or packaging. No burnt taste. Unacceptable salty flavor, no sweet flavor.

Formulation 5G

| | |
|---|---|
| Ingredient | g/bag |
| Popcorn | 66.00 |
| Hydrogenated Soybean Oil | 29.46 |
| Sucralose | 0.04 |
| Salt (Morton-200 fine) | 3.5 |

Comments: No burning of popcorn or packaging. No burnt taste. Unacceptable salty flavor, no sweet flavor.

14Conclusions from formulations 5A through 5G:Formulations 5A through 5G were formulated with different levels of salt while maintaining the same level of sucralose. At all levels tested there was no burning of the popcorn or of the packaging. The combination of sucralose and salt in a microwave popcorn product can be used together without a negative physical effect on the popcorn or packaging. The preferred sucralose level based on a popcorn composition of 99 grams total (where the popcorn is 66 grams) is about 0.04 gram per bag, when combined with salt at levels of 1 1.5 grams salt per bag. At theses salt levels, the product has an acceptable range of sweet and salty flavor combination characteristic of the product. The percentage ratio of salt to sucralose in a preferred formula would typically be about 96.2 wt-% salt and 3.8 wt-% sucralose to about 97.4 wt-% salt and 2.6 wt-% sucralose, with a preferred percentage of about 97.5 wt-% salt to 2.5 wt-% sucralose.

General Conclusions from ExperimentsNatural sweeteners like sugar (sucrose), maltodextrins and corn syrup solids have the ability to sweeten microwave popcorn without contributing any bitter/burnt flavors from the microwave cooking process. However, if a product is formulated containing both a natural sweetener and a minimum amount of salt, the popped popcorn and inner package walls exhibit an unacceptable level of burning. This burning provides an unacceptable taste to the product.

However, when sucralose is used as the sweetening agent in salted microwave popcorn formulations, an acceptable level of sweetness is achieved, as is an extremely low level of burnt particles on the popped popcorn. A microwave popcorn formulation that contains both salt and sucralose, the sucralose being at least of 0.01 gram per bag and not more than 0.1 gram per bag (based on a bag with 99 grams of charge, of which 66 grams is popcorn), has acceptable sweet and salty flavor. Formulations having a natural sweetener added to the combination of sucralose and salt tend to exhibit an unacceptable level of burning on the inner package wall and on the popped popcorn.

To formulate a sweet and salty microwave popcorn, the preferred formulation is a combination of sucralose and salt without the other natural sweeteners, at least at the levels tested. The preferred level of sucralose is no less than 0.01 gram/bag and no more than 0.10 gram/bag, based on a 99 grams composition that has 66 grams popcorn. The sucralose can be present at a level of at least 0.02 weight-% of the popcorn composition.

Claims

1.A microwaveable popcorn composition, which, upon popping, provides a popped popcorn product having a sweet and salty taste; said popcorn composition comprising:
(a)unpopped popcorn;
(b)an oil/fat component;
(c)salt, present at a level of at least 0.8 wt-% of the total popcorn composition; and,
(d)a sweetening effective amount of sucralose.

2.A composition according to claim 1 wherein:
(a)the salt is present at a level of no more than 2 wt-% of the total composition; and,
(b)the sucralose is present at a level of at least 0.01 wt-% of the total composition.

3.A composition according to claim 2 wherein:
(a)the sucralose is present at a level of 0.02 to 0.2 wt-% of the total composition.

4.A composition according to claim 1 wherein:
(a)the unpopped popcorn is present at a level of 64 to 70 wt-% of the total composition.

5.A composition according to claim 4 wherein:
(a)the oil/fat component is present at a level of 29 to 33 wt-% of the total composition; and,
(b)the composition comprises:
(i)less than 2 wt-% monosaccharides;
(ii)less than 2 wt-% non-sucralose disaccharides; and,
(iii)less than 2 wt-% corn syrup solids.

6.A composition according to claim 5, wherein:
(a)the composition comprises:
(i)less than 1 wt-% monosaccharides;
(ii)less than 1 wt-% non-sucralose disaccharides; and,
(iii)less than 1 wt-% corn syrup solids.

7.A composition according to claim 4 consisting essentially of:
(a)64 to 70 wt-% unpopped popcorn;
(b)29 to 33 wt-% oil/fat component;
(c)0.9 to 1.8 wt-% salt; and
(d)0.02 to 0.2 wt-% sucralose.

8.A microwave popcorn product comprising:
(a)a container suitable for use in a microwave popcorn popping process;
(b)a microwave popcorn composition positioned inside the container and comprising:
(i)unpopped popcorn;
(ii)an oil/fat component;
(iii)at least 0.8 wt-% salt; and
(iv)a sweetening effective amount of sucralose; and,
(c)a microwave interactive construction positioned in thermoconductive relation to the microwave popcorn composition.

9.A microwave popcorn product according to claim 8 wherein the sucralose is at least 0.02 weight-% of the popcorn composition.

10.A microwave popcorn product according to claim 9 wherein the microwave popcorn composition comprises:
(a)less than 0.6 wt-% monosaccharides;
(b)less than 0.6 wt-% non-sucralose disaccharides; and,
(c)less than 0.6 wt-% corn syrup solids.

11.A microwave popcorn product according to claim 8 wherein:
(a)the microwave interactive construction comprises an aluminized polymer sheet.

12.A product according to claim 8 wherein:
(a)the container is a bag construction.

13.A product according to claim 12 wherein:
(a)the bag construction comprises a two-ply construction with the microwave interactive construction positioned between an inner ply and an outer ply.

14.A product according to claim 12 wherein:
(a)the microwave popcorn composition has a weight of about 99 grams, of which about 66 grams are unpopped popcorn.

15.A product according to claim 8 wherein:
(a)the container is a fiberboard tub.

16.A method of preparing a sweet and salty popcorn food; said method comprising a step of:
(a)popping popcorn by microwave treating an unpopped popcorn composition including unpopped popcorn in the presence of: an oil/fat component; an adequate amount of salt to provide a salty taste; and, a sweetening effective amount of sucralose.

17.A method according to claim 16 wherein:
(a)the step of popping comprises microwave treating an unpopped popcorn composition including 0.9 to 1.8 wt-% salt.

18.A method according to claim 16 wherein:
(a)the step of popping comprises microwave treating an unpopped popcorn composition including 0.02 to 0.2 wt-% sucralose.

19.A method according to claim 16 wherein:
(a)the step of popping comprises microwave treating an unpopped popcorn composition including about 66 wt-% unpopped popcorn.

20. A method according to claim 16 wherein:
(a)the step of popping comprises microwave treating an unpopped popcorn composition including about 29 to 33 wt-% oil/fat component.

21.A microwave popcorn product according to claim 9 wherein the microwave popcorn composition comprises:
(a)no more than 0.6 wt-% monosaccharides, if any;
(b)no more than 0.6 wt-% non-sucralose disaccharides, if any; and,
(c)less than 0.5 wt-% corn syrup solids, if any.

22. A microwaveable popcorn composition, which, upon popping, provides a popped popcorn product having a sweet and salty taste; said popcorn composition comprising:
(a)unpopped popcorn;
(b)an oil/fat component;
(c)salt, present at a level to provide a salty taste; and
(d)a sweetening effective amount of sucralose.

23. A composition according to claim 22 wherein:
(a)the salt is present at a level of at least 0.8 wt-% of the total popcorn composition.

24. A composition according to claim 22 wherein:
(a)the salt is present at a level of no more than 2 wt-% of the total popcorn composition.

25. A composition according to claim 22 wherein:
(a)the salt in the popcorn composition is present at a level of at least 0.5 grams per 66 grams of unpopped popcorn.

26. A composition according to claim 22 wherein:
(a)the sucralose is present at a level of at least 0.01 wt-% of the total popcorn composition.

27. A composition according to claim 26 wherein:
(a)the sucralose is present at a level of 0.02 to 0.2 wt-% of the total popcorn composition.

28. A composition according to claim 22 wherein:
(a)the unpopped popcorn is present at a level of greater than 55 wt-% of the total popcorn composition.

29. A composition according to claim 22 wherein:
(a)the oil/fat component is present at a level of greater than 25 wt-% of the total popcorn composition; and,
(b)the composition comprises:
(i)less than 2 wt-% monosaccharides, if any;
(ii)less than 2 wt-% non-sucralose disaccharides, if any; and,
(iii)less than 2 wt-% corn syrup solids, if any.

30. A composition according to claim 22 comprising:
(a)greater than 55 wt-% unpopped popcorn;
(b)greater than 25 wt-% oil/fat component;
(c)at least 0.8 wt-% and no more than 2 wt-% salt; and
(d)at least 0.01 wt-% sucralose.

31.A composition according to claim 22 consisting essentially of:
(a)64 to 70 wt-% unpopped popcorn;
(b)29 to 33 wt-% oil/fat component;
(c)0.9 to 1.8 wt-% salt; and
(d)0.02 to 0.2 wt-% sucralose.

32. A composition according to claim 22 comprising:
(a)at least 0.8 wt-% and no more than 2 wt-% salt;
(b)at least 0.01 wt-% sucralose;
(c)no more than 0.6 wt-% monosaccharides, if any;
(d)no more than 0.6 wt-% non-sucralose disaccharides, if any, the total of the monosaccharides and non-sucralose disaccharides being less than about 1 wt-%; and,
(e)less than 0.5 wt-% corn syrup solids, if any.

33. A composition according to claim 32 wherein:
(a)the sucralose is present at a level of at least 0.02 wt-%.

34. A composition according to claim 33 wherein:
(a)the sucralose is present at a level of 0.02 to 0.2 wt-%.

35. A composition according to claim 32 wherein:
(a)the salt is present at a level of 0.9 to 1.8 wt-%.

36. A composition according to claim 22 wherein:
(a)the unpopped popcorn is present at a level of greater than 55 wt-%;
(b)the oil/fat component is present at a level of greater than 25 wt-%;
(c)the salt is present at a level of at least 0.8 wt-% and no more than 2 wt-%;
(d)the sucralose is present at a level of at least 0.01 wt-%;
(e)monosaccharides, if any, are present at a level of less than 2 wt-%;
(f)non-sucralose disaccharides, if any, are present at a level of less than 2 wt-%; and
(g)corn syrup solids, if any, are present at a level of less than 2 wt-%.

37. A composition according to claim 36 wherein:
(a)the salt is present at a level of 0.9 to 1.8 wt-%.

38. A microwave popcorn product comprising:
(a)a container suitable for use in a microwave popcorn popping process;
(b)a microwave popcorn composition positioned inside the container and comprising:
(i)unpopped popcorn;
(ii)an oil/fat component;
(iii)salt, present at a level to provide a salty taste;
(iv)sucralose, present at a level of at least 0.02 wt-% of the total popcorn composition; and
(c)a microwave interactive construction positioned in thermoconductive relation to the microwave popcorn composition.

39. A microwave popcorn product according to claim 38 wherein:
(a)the salt is present at a level of at least 0.8 wt-% and no more than 2 wt-% of the total popcorn composition.

40. A microwave popcorn product according to claim 39 wherein:
(a)the container is a bag construction.

41. A microwave popcorn product according to claim 39 wherein:
(a)the container is a fiberboard tub.

42. A microwave popcorn product according to claim 38 wherein:
(a)the salt is present at a level of at least 0.5 grams per 66 grams of unpopped popcorn.

43. A microwave popcorn product according to claim 42 wherein:
(a)the container is a bag construction.

44. A microwave popcorn product according to claim 42 wherein:
(a)the container is a fiberboard tub.
